(19) United States
(12) Patent Application Publication
(10) Pub. No.: US 2009/0213303 A1
(43) Pub. Date: Aug. 27, 2009

(54) DISPLAY APPARATUS AND DISPLAY SUBSTRATE THEREOF

(75) Inventor: Cheng-Chi Yen, Tainan County (TW)

Correspondence Address: J C PATENTS, INC., 4 VENTURE, SUITE 250, IRVINE, CA, 92618, US

(73) Assignee: HIMAX DISPLAY, INC., Tainan County (TW)

(21) Appl. No.: 12/037,322

(22) Filed: Feb. 26, 2008

(51) Int. Cl. G02F 1/1333

(52) U.S. Cl. 349/84

(57) ABSTRACT

In a display apparatus, a light source is used for emitting light and a display panel is used for displaying images. The display panel includes a display area having a plurality of display pixels, a dark ring surrounding the display area and having a plurality of black pixels. Wherein adjacent two of the black pixels have an opening there-between, and a light sensing unit being integrated into the substrate and disposed beneath the opening of the two adjacent black pixels.

### BACKGROUND OF THE INVENTION

1. Field of Invention

The present invention relates to a display apparatus and a display substrate thereof, wherein a photo sensing unit is integrated in the display substrate.

2. Description of Related Art

At present time, electronic display apparatuses are more important as information transmission media and various electronic display apparatuses are widely applied for industrial apparatus or home appliances. Such electronic display apparatuses continue to advance to have new appropriate functions for various demands of the information society.

In general, electronic display apparatuses display and transmit various pieces of information to users. That is, the electronic display apparatuses convert electronic information signals outputted from an electronic apparatus into light information signals recognized by users' vision.

The electronic display apparatuses are generally divided into emissive display apparatuses and non-emissive display apparatuses. The emissive display apparatuses display light information signals through emitting lights, and the non-emissive display apparatus displays the light information signals through reflection, scattering or interference. The emissive display apparatuses include a cathode ray tube (CRT), a plasma display panel apparatus (PDP), a light emitting diode (LED) and an electroluminescent display apparatus (ELD). The emissive display apparatuses are called as active display apparatuses. Also, the non-emissive display apparatuses, called as passive display apparatuses, include a liquid crystal display apparatus (LCD), an electrochemical display apparatus (ECD) and an electrophoretic image display apparatus (EPID).

As technology of semiconductor has been developed, the demand for new electronic display apparatuses has been greatly increased, such as a flat panel display apparatus which has excellent characteristics, for example, a thin thickness, a light weight, a low driving voltage and a low power consumption. The flat panel display apparatuses can be manufactured using the rapidly improving semiconductor technology.

Now, solid-state light emitters (e.g., light emitting diodes) may be used as light sources in electronic display apparatuses. A problem with light sources comprised of one or more solid-state light emitters is that the intensity of light emitted by a solid-state light emitter is subject to change as a result of changes in its temperature and aging. Furthermore, the characteristics (and thus the light emitting capabilities) of solid-state light emitters may vary from batch to batch. As a result, in systems where the integrity of light emitted by a light source needs to be maintained (e.g., in display backlighting and illumination systems), some sort of system is needed to measure and regulate the light source's light.

A photo diode is used for a complementary metal-oxide semiconductor (CMOS) image sensor, which is manufactured by CMOS processes, to detect light. Since the photo diode is formed in a PNP or NPN junction structure buried in a substrate, the photo diode is referred to as a buried photo diode. The CMOS image sensor is subject to less power consumption and is manufactured by a simpler process. Moreover, the CMOS image sensor can be formed together with a signal processing circuit in one chip, making it attractive as a next-generation image sensor.

Therefore, it needs a display apparatus, which is capable of real-time detecting and adjusting an intensity of ambient light from a light source, having advantages of low fabrication cost and saved circuit area.

### SUMMARY OF THE INVENTION

The invention provides a display panel and a display substrate using the same, wherein a light sensing unit is integrated into the display panel and fabricated along with other circuitry inside the display apparatus during the same fabrication process.

One example of the invention provides a display apparatus comprising a light source for emitting light and a substrate. The substrate includes a display area having a plurality of display pixels, a dark ring surrounding the display area and having a plurality of black pixels. Wherein adjacent two of the black pixels have an opening there-between, and a light sensing unit formed on a surface of the substrate and disposed beneath the opening of the two adjacent black pixels.

In one embodiment of the invention, the black pixels are electrically isolated from the display pixels. The substrate further comprises a metal layer to form the black pixels. The substrate further comprising a driving circuit to drive the black pixels for displaying a black image, and a controlling circuit for adjusting light emitted by the light source in accordance with the light sensing unit.

In another embodiment of the invention, the display apparatus is an LCOS display. Further, the black pixels and the light sensing unit are formed during the same fabrication process. The light sensing unit may include one or more photodiodes. The photodiode(s) may be formed by a well-substrate junction of the substrate. Alternatively, the photodiode(s) may be formed by a diffusion-substrate junction of the substrate. The light source comprises one or more LEDs.

Another example of the invention provides a display panel comprising a display area having a plurality of display pixels, a dark ring surrounding the display area and having a plurality of black pixels. Wherein adjacent two of the black pixels have an opening there-between, and a light sensing unit formed on a surface of the substrate and disposed beneath the opening of the two adjacent black pixels.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a block diagram for a display apparatus according to an embodiment of the invention.

FIG. 2 shows the substrate 120 according to the embodiment of the invention.

FIG. 3 shows photodiodes (PD) integrated into the substrate according to the embodiment of the invention.

FIG. 4a and FIG. 4b shows two examples of the photodiodes according to the embodiment of the invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

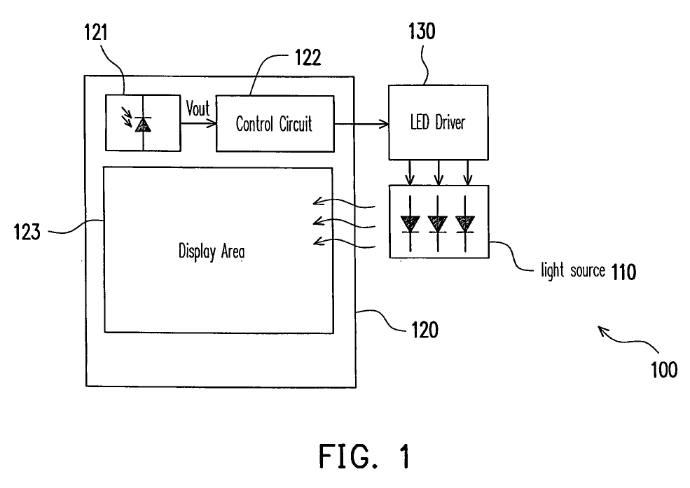

FIG. 1 shows a block diagram for a display apparatus according to an embodiment of the invention. As shown in FIG. 1, the display apparatus 100 according to the embodiment of the invention includes a light source 110, a substrate 120 and an LED driver 130. In this embodiment, the display apparatus 100 is for example but not limited to an LCOS (liquid crystal on silicon) display and the substrate is a silicon substrate for an LCOS panel.

The light source 110 is used for emitting light. The light source 110 comprises LEDs. Further, the light source 110 may comprise red, green blue and/or white LEDs.

The substrate 120 comprises a light sensing unit 121, a control circuit 122 and a display area 123. The display area 123 has a plurality of display pixels thereon. The output light of the light source illuminates the display area. The display pixels reflect the incident light and display an image to a viewer.

The light sensing unit 121 is formed on a surface of the substrate 120. The light sensing unit 121 is used for detecting light emitted from the light source 110 and for converting the detection result into a detection signal Vout. The light sensing unit 121 includes at least one photodiode. Further, the photodiodes in the light sensing unit 121 are arranged in one dimension or two dimensions. Alternatively, the photodiodes in the light sensing unit 121 are used for measuring different wavelengths of light.

The detection signal Vout from the light sensing unit 121 is sent to the control circuit 122. In accordance with the detection signal Vout, the control circuit 122 adjusts the emitted light of light source 110. For example, as shown in the figure, the control circuit 122 couples to the LED driver 130 and controls the emitted light via the driver. Further, the control circuit 122 is operably associated with the light sensing unit 121 and the light source 110, to regulate the output light of light source in accordance with detection by the light sensing unit 121.

Still further, different photodiodes in the light sensing unit 121 may measure different wavelengths of light, such as red, green and blue wavelengths, The control circuit 122 separately regulates the intensities of red, green and blue LEDs in the light source 110 in accordance with the detection signal Vout received from the light sensing unit 121.

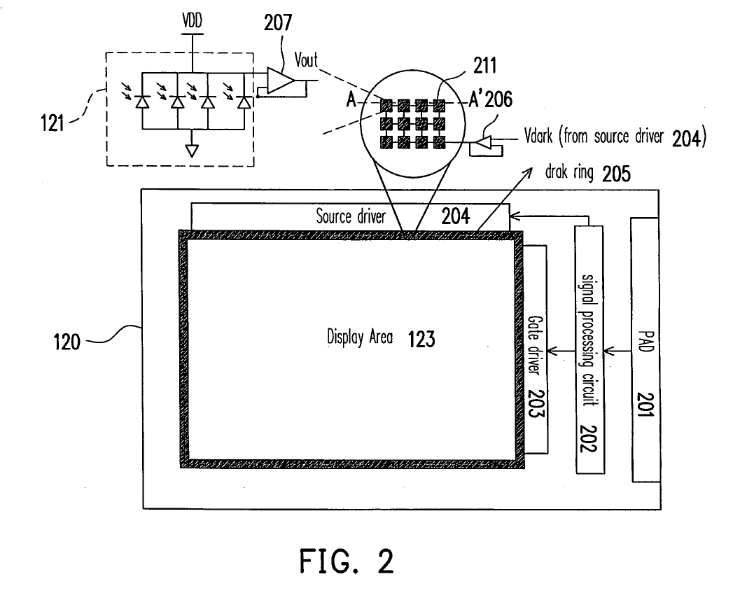

FIG. 2 shows the display substrate 120 according to the embodiment of the invention. As shown in FIG. 2, the substrate 120 further includes the display area 123, a signal pad 201, a signal processing circuit 202, a gate driver 203, a source driver 204 and a dark ring 205. In the embodiment, the signal pad 201, the signal processing circuit 202, the gate driver 203 and the source driver 204 are not specially limited.

The dark ring 205 is adjacent to surrounds the display area 123. Alternatively, the dark ring 205 surrounds the display area 123. The dark ring 205 has a plurality of black pixels 211. As shown in FIG. 2, adjacent two of the black pixels 211 have an opening there-between. The light sensing unit 121 is disposed beneath the openings of the black pixels 211. Emitting light from the light source 110 passes through the openings between the black pixels 211 and reaches the light sensing unit 121. Detection results from the light sensing unit 121 are amplified by a buffer 207 as the detection signal Vout.

The black pixels 211 are formed by a metal layer. The source driver 204 drives the black pixels 211 through a buffer 206 for displaying black images by a driving voltage Vdark. In other words, the black pixels of the dark ring block the emitting light from the light source in order to prevent the reflected light except the display area effects the display image, and only a little emitting light will pass through the openings between the black pixels 211. The black pixels 211 are electrically isolated from the display pixels of the display area 123.

Further, the black pixels 211 and the photodiodes of the light sensing unit 121 may be formed by the same fabrication process, such as CMOS process. Further, the display pixels of the display area 123, the signal pad 201, the signal processing circuit 202, the gate driver 203 and the source driver 204 are fabricated on the same substrate, so they may be formed by the same fabrication process. So that, according to the embodiment of the invention, the layout size and cost of the substrate integrating the photodiodes may be saved.

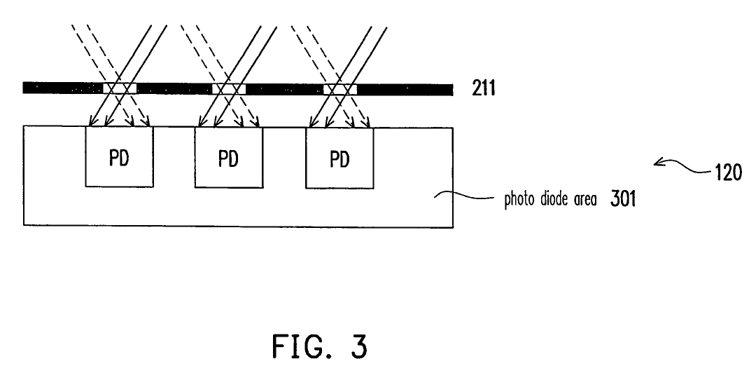

FIG. 3 shows the photodiodes (PD) integrated into the substrate 120 according to the embodiment of the invention. As shown in FIG. 3, it is a cross-section view of the photodiode PD beneath the black pixels 211 of FIG. 2 along A-A′ segment. The photodiodes PD are formed on a surface of the substrate 120. Further, the photodiodes PD are disposed beneath the openings between the adjacent black pixels 211. Further, the area where the photodiodes are formed is called a photodiode area 301. So that, light emitted from the light source 110 passes through the openings and is sensed by the photodiodes PD beneath the openings.

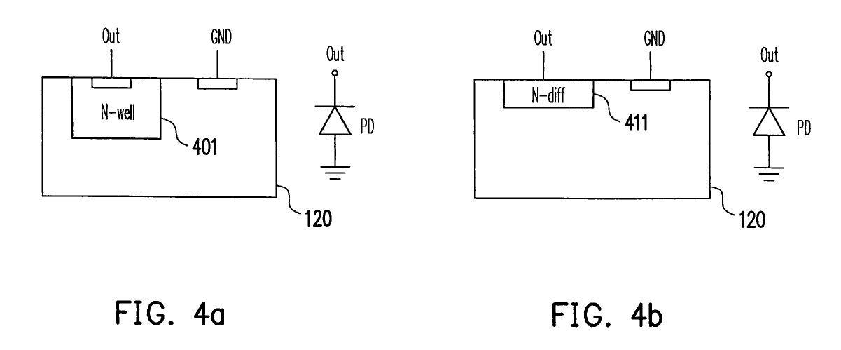

FIG. 4a and FIG. 4b shows two examples of the photodiodes according to the embodiment of the invention. In FIG. 4a, the photodiode is formed by a well-substrate junction of the substrate 120. The well-substrate junction is a junction formed between the p-substrate 120 and the N-type well 401. In other words, in this case, the photodiode area 301 in FIG. 3 is formed in the N-type well 401 of different conductive type with the P-type substrate 120; and each photodiode is defined by a junction between the N-type well 401 and the substrate 120.

In FIG. 4b, the photodiode is formed by a diffusion-substrate junction of the substrate 120. The diffusion-substrate junction is a junction formed between the p-substrate 120 and the N-type diffusion region 411. In other words, in this case, the photodiode area 301 in FIG. 3 is formed in the N-type diffusion region 411 of different conductive type with the P-type substrate 120; and each photodiode is defined by a junction between the N-type diffusion region 411 and the P-type substrate 120.

As stated above, the photodiodes are integrated into the substrate of the display panel of the display apparatus, so the photodiodes and other circuits in the display apparatus may be formed during the same fabrication process. Therefore, fabrication cost and circuit layout size of the display panel in the display apparatus according to the embodiment is further saved.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A display apparatus comprising:
a light source for emitting light; and
a substrate, comprising:
a display area having a plurality of display pixels;
a dark ring surrounding the display area, the dark ring having a plurality of black pixels, wherein adjacent two of the black pixels have an opening there-between; and
a light sensing unit formed on a surface of the substrate and disposed beneath the opening of the two adjacent black pixels.

2. The display apparatus of claim 1, wherein the black pixels are electrically isolated from the display pixels.

3. The display apparatus of claim 1, wherein the substrate further comprising a metal layer to form the black pixels.

4. The display apparatus of claim 1, wherein the substrate further comprising a driving circuit to drive the black pixels for displaying a black image.

5. The display apparatus of claim 1, wherein the substrate further comprising a controlling circuit for adjusting light emitted by the light source in accordance with the light sensing unit.

6. The display apparatus of claim 1, wherein said display apparatus is an LCOS display.

7. The display apparatus of claim 1, wherein the black pixels and the light sensing unit are formed during the same fabrication process.

8. The display apparatus of claim 1, wherein the light sensing unit is a photo diode.

9. The display apparatus of claim 8, wherein the photodiode is formed by a well-substrate junction of the substrate.

10. The display apparatus of claim 8, wherein the photodiode is formed by a diffusion-substrate junction of the substrate.

11. The display apparatus of claim 1, wherein the light source comprises LEDs.

12. A display panel comprising:
a substrate, comprising:
a display area having a plurality of display pixels;
a dark ring surrounding the display area, the dark ring having a plurality of black pixels, wherein adjacent two of the black pixels have an opening there-between; and
a light sensing unit formed on a surface of the substrate and disposed beneath the opening of the two adjacent black pixels.

13. The display panel of claim 12, wherein the black pixels are electrically isolated from the display pixels.

14. The display panel of claim 12, wherein the substrate further comprising a metal layer to form the black pixels.

15. The display panel of claim 12, wherein the substrate further comprising:
a driving circuit to drive the black pixels for displaying a black image; and
a controlling circuit for adjusting light emitted by a light source in accordance with the light sensing unit.

16. The display panel of claim 12, wherein said display panel is an LCOS panel.

17. The display panel of claim 12, wherein the black pixels and the light sensing unit are formed during the same fabrication process.

18. The display panel of claim 12, wherein the light sensing unit is a photodiode.

19. The display panel of claim 18, wherein the photodiode is formed by a well-substrate junction of the substrate.

20. The display panel of claim 18, wherein the photodiode is formed by a diffusion-substrate junction of the substrate.
